(19) United States
(12) Patent Application Publication
(10) Pub. No.: US 2022/0074390 A1
(43) Pub. Date: Mar. 10, 2022

(54) A METHOD AND A SYSTEM FOR DETERMING THE WIND SPEED OR THE WIND DIRECTION EXPERIENCED BY A WIND TURBINE

(71) Applicant: ROMO Wind AG, Einsiedeln (CH)

(72) Inventor: Nick Gerardus Cornelis Janssen, . (DK)

(73) Assignee: ROMO Wind AG, Einsiedeln (CH)

(21) Appl. No.: 17/309,820

(22) PCT Filed: Dec. 17, 2019
(86) PCT No.: PCT/EP2019/085727

§ 371 Date: Jun. 21, 2021

(30) Foreign Application Priority Data
Dec. 21, 2018 (EP) 18215570 5

(51) Int. Cl. F03D 17/00; G01P 13/04

(52) U.S. Cl. CPC F03D 17/00; G01P 13/045; G01P 5/24; F05B 2270/32; F05B 2270/321

(57) ABSTRACT

A method for determining the wind speed or the wind direction experienced by a wind turbine such that a wind turbine setting such as an inflow angle error may be adjusted based on the determined wind speed or wind direction is defined, wherein a single airflow sensor is used together with a position sensor such as an accelerometer so that the value of the single airflow sensor at a previous position of the rotor may be warped and used together with a value of the single airflow sensor of a current position.

The present invention relates to a method and a system for determining the wind speed or the wind direction experienced by a wind turbine.

The power output of a wind turbine and the loads exerted on the wind turbine by the wind are to a large extent dependent on the orientation of the wind turbine with respect to the wind.

In order for the wind turbine to be optimally adjusted, the wind speed and/or direction need to be known and are key variables in controlling power and loads.

The relative wind direction, or the yaw error, is an expression of how good the wind turbine is to find the accurate wind direction.

Maximizing the power is almost the same as minimizing the yaw error, because a larger projected rotor area will be exposed to the wind. Minimizing the yaw error is also a minimization of the dynamic loads, and thus minimization of fatigue.

The wind speed is used for pitch control and regulation of power at higher wind speeds, and it is also being used for determination of the power performance of the wind turbine. Optimization of power and loads is therefore dependent on quite accurate measurements of the wind that the wind turbine experiences.

In addition, accurate measurement of the wind speed and direction allows the power performance of the wind turbine to be determined accurately. Accurate power performance data for a wind turbine is very important for proper adjustment and monitoring of wind turbines.

In order to measure the speed and direction of the wind, a cup anemometer and a wind vane may be mounted on the roof of the wind turbine's nacelle. However, the wind measurement is placed behind the rotor plane, and the rotor introduces turbulence and therefore the wind measured by the wind sensor will be different from the wind in front of the rotor.

In addition, if the wind is coming at an angle, either horizontally or vertically, the nacelle of the wind turbine introduces vortices and boundary layer effects, which may heavily influence the wind sensors.

Alternatively, a rotor sensor such as an anemometer or a sonic anemometer may be mounted in front of the rotor plane, which may provide a more precise measurement than the nacelle mounted wind vanes.

An example of a wind turbine having a sonic anemometer mounted in front of the rotor plane is disclosed in EP1733241, which is incorporated in the present disclosure by reference.

A rotor sensor having an offset with respect to the center of the rotor, i.e. not being placed directly at the center of the rotor may return a varying output as a function of rotor position (rotor angle) when an inflow angle of the wind and the orientation of the wind turbine are not aligned.

The orientation of the wind turbine may be adjusted so that the sensor output varies as little as possible, which may be an indication that an inflow angle error is minimized, and the orientation of the wind turbine is aligned to the inflow angle (at least in a horizontal plane).

It is an object of the present invention to provide a cost effective and direct method of measuring the mean wind speed and/or direction experienced by the center of the wind turbine's rotor.

The above object and advantages together with numerous other objects and advantages, which will be evident from the description of the present invention, are according to a first aspect of the present invention obtained by:

A method for determining the wind speed or the wind direction experienced by a wind turbine such that a wind turbine setting such as an inflow angle error may be adjusted based on the determined wind speed or wind direction, said method comprising:
providing said wind turbine having a tower, a nacelle, and a rotor,

said rotor including a hub, a number of wind turbine blades mounted to said hub, and a spinner surface for diverting an airflow around said hub,

said method further comprising:
providing an angular sensor, and determining the rotor position by means of said angular sensor,
providing an airflow sensor at said spinner surface, said airflow sensor rotating with said rotor during rotation of said rotor,
determining an airflow variable by means of said airflow sensor as a function of rotor positions during a rotation of said rotor, said airflow variable varying with said rotor position when said inflow angle error being different from zero,
determining a first airflow value corresponding to the value of said airflow variable at a first rotor position,
determining a second airflow value corresponding to the value of said airflow variable at a second rotor position, said second rotor position being substantially ⅙ to 4/6 of a rotation before said first rotor position, and
determining the wind speed or the wind direction experienced by said wind turbine as a function of said first airflow value, and said second airflow value.

The airflow variable may be air velocity or air pressure.

In an embodiment of the method the first airflow value AV1 corresponding to the value of the airflow variable at the first rotor position is measured at time t₁. The second airflow value AV2 corresponding to the value of said airflow variable at the second rotor position is measured at time t₂.

The second airflow value AV2 at second the time t₂ is, preferably, measured before the first airflow value AV1 at the first time t₁ is measured, If t₁ is measured at about 360° at the first position (i.e. after one rotation, referring to the rotation of the rotor), time t₂ may be measured before t₁ after about halt a rotation, e.g. about 180°. The wind speed and wind direction at time t₁ can then be calculated using the measurements of airflow values taken at the first and second rotor positions at time t₁ and t₂. The corresponding values AV1 and AV2 are computed to time t₁, and used for determining the actual wind speed U and optional wind direction at time t₁. The principles in calculating and determining the wind speed and wind direction is explained in further details below.

The wind speed may then be calculated using only the results AV1 at time t₁ at the full rotation of about 360° and AV2 measured after about halt a rotation, e.g. at the second rotor position at about 180° and at time t₂. The value of AV2 is then computed to time t₁ and used to the calculation of the wind U speed and optional wind direction at time t₁. Thus, the method is applicable for calculation wind values after half a rotation of the rotor.

In an embodiment of the method according to the invention, the method may also comprise determining a third airflow value AV3 corresponding to the value of said airflow variable at a third rotor position at time t₃, and determining the wind speed or the wind direction experienced by said wind turbine as a function of said first airflow value, said second airflow value, and said third airflow value.

Thus, the first airflow value AV1, the second airflow value AV2, and the third airflow value AV3 may be measured at time t₁, t₂ and t₃, respectively. AV3 may be measured at time t₃ at a third rotor position of about 240° rotation and the second airflow value AV2 at time t₂ at a second rotor position of about 120° and the first airflow value AV1 at time t₁ after one rotation and a first rotor position of about 360°, respectively. The airflow values at time t₂ and t₃ are then computed to time t₁ and used to the calculation of the wind U speed and optional wind direction at time t₁. The third airflow value AV3 at time t₃ at about 240° rotation is measured after the second airflow value AV2 at time t₂ at about 120°. However, AV2 and AV3 are measured before the first airflow value AV1 at time t₁ after a rotation of about 360°.

It is clear that measurements at other rotor positions than the above mentioned may be used for the determination of the wind speed at the first rotor position. Consequently, the present invention provides a method where airflow values can be measured using only a single airflow sensor on the spinner. The single sensor measures airflow values at different positions and times when the spinner rotates and these measurements are used for determining the wind at a specific time during the rotation of the spinner.

In an embodiment of the method according to the invention the second rotor position is about 120° to about 240° of a rotation before the first rotor position, said first rotor position being about 360° of a rotation.

In an embodiment the third rotor position is about 240° of a rotation before the first rotor position, the first rotor position being at about 360° of a rotation.

The wind speed experienced by the wind turbine is to be understood as the free wind speed, i.e. the wind speed in the case that the wind turbine had not been in the landscape. The same is to be understood with respect to the wind direction or inflow angle, i.e. the angle in the case that the wind turbine had not been in the landscape.

The inflow angle has an azimuth component defining the inflow angle in a horizontal plane, and a polar component defining the inclination with respect to the horizontal plane (flow inclination angle).

The hub may have a surface geometry (spinner surface) which is configured to allow a smooth airflow around the hub. The surface of the hub may be constituted as a surface of a separate glass fiber shell in the shape of a hemisphere constituting a spinner mounted to the hub—the surface covering the areas where the hub-end (blade root) of the wind turbine blades are mounted to the hub.

At said spinner surface is to be understood as in a plane of the surface of the spinner or elevated a defined distance from the surface for example by using an arm. By using an arm or rod, the measurement will take place at the defined distance above the surface. The distance may be less than 0.5 meter such as less than 0.25 m.

A single airflow sensor for measuring an airflow variable at said spinner surface is provided. A single airflow sensor for measuring an airflow variable at said spinner surface is to be understood as only one airflow sensor at said spinner surface, i.e. there are not more than one airflow sensor for measuring an airflow variable at said spinner surface—not withstanding any sensor mounted to a wind turbine blade or nacelle.

The angular sensor may be an accelerometer such as a 1D or 3D accelerometer or a pair of magnets mounted to the rotor and nacelle respectively such that a current is generated each time the magnets pass each other when the rotor has done one rotation.

Several pairs of magnets may be provided such that the rotor position may be know for more than one angle—the pairs of magnets may be placed substantially equidistant with respect to each other. Substantially equidistant meaning not deviating with more than 20%.

Rotor position means the angle of the rotor, i.e. the rotor is mounted to the nacelle, and has a rotor axis, which the rotor rotates around.

A wind turbine setting may also be the pitch of a wind turbine blade.

According to a second aspect of the present invention, the above objects and advantages are obtained by:

A method for determining the wind speed or the wind direction experienced by a wind turbine such that a wind turbine setting such as an inflow angle error may be adjusted based on the determined wind speed or wind direction, said method comprising:
providing said wind turbine having a tower, a nacelle, and a rotor,

said rotor including a hub, a number of wind turbine blades mounted to said hub, and a spinner surface for diverting an airflow around said hub,

said method further comprising:
providing a single airflow sensor at said spinner surface, said single airflow sensor rotating with said rotor during rotation of said rotor,
determining an airflow variable by means of said single airflow sensor as a function of time during a rotation of said rotor, said airflow variable varying with said rotor position when said inflow angle error being different from zero,
determining a first airflow value corresponding to the value of said airflow variable at a first time point,
determining a second airflow value corresponding to the value of said airflow variable at a second time point, and
determining the wind speed or the wind direction experienced by said wind turbine as a function of said first airflow value, and said second airflow value.

According to a third aspect of the present invention, the above objects and advantages are also obtained by:

A method for determining the wind speed or the wind direction experienced by a wind turbine such that a wind turbine setting such as an inflow angle error may be adjusted based on the determined wind speed or wind direction, said method comprising:
providing said wind turbine having a tower, a nacelle, and a rotor,

said rotor including a hub, a number of wind turbine blades mounted to said hub, and a spinner surface for diverting an airflow around said hub,

said method further comprising:
providing an angular sensor, and determining the rotor position by means of said angular sensor as a function of time during a rotation, said rotor position being determined at least at a first rotor position,
providing an airflow sensor at said spinner surface, said airflow sensor rotating with said rotor during rotation of said rotor,
determining the values of an airflow variable by means of said airflow sensor as a function of time during a rotation of said rotor, the values of said airflow variable varying with said rotor position when said inflow angle error being different from zero,
at a second rotor position:
   a) determining at which first time point said rotor is at said first rotor position,
   b) determining the value of said airflow variable at said second rotor position, and determining the value of said airflow variable at said first time point corresponding to when said rotor is at said first rotor position,
   c) determining the wind speed or the wind direction experienced by said wind turbine as a function of the value of said airflow variable at said second rotor position and the value of said airflow variable at said first time point corresponding to when said rotor is at said first rotor position.

Thus, according to the invention the wind speed or the wind direction experienced by the wind turbine can be determined using a single air flow sensor and measure one or more airflow variables at specific rotor positions during the rotation of the rotor. Preferably, two or more measurements are used for the determination of the wind speed or the wind direction.

The invention also relates to a method for determining the wind speed and/or the wind direction experienced by a wind turbine such that a wind turbine setting such as an inflow angle error may be adjusted based on the determined wind speed or wind direction, said method comprising:
providing said wind turbine having a tower, a nacelle, and a rotor,

said rotor including a hub, a number of wind turbine blades mounted to said hub, and a spinner surface for diverting an airflow around said hub,

said method further comprising:
optionally providing an angular sensor, and determining the rotor position by means of said angular sensor,
providing a single airflow sensor at said spinner surface, said spinner and said airflow sensor rotate with said rotor during rotation of said rotor, said airflow sensor rotates with an angle φ in the range between 0°-360° relative to the centre axis of the rotor, where the angles 0° and 360° constitute the start and the end position of the airflow sensor during one rotation of the rotor,

said method comprises the step of:

measuring a second airflow value p₂ at position φ₂ at time t₂,

measuring a first airflow value p₁ at position φ₁ at time t₁, where t₁ is different from t₂,

determining substantially at time t₁ on basis of the measured values for p₁ and p₂ the wind speed and/or wind direction.

The term “substantially” should herein be taken to mean that ordinary product variances and tolerances are comprised. In the above context “substantially” should mean +/−2 seconds from t₁, such as +/−3 seconds from t₁.

In a preferred embodiment the position at φ₁ is the position at 360°.

The calculations required for the determination of the wind speed and/or wind direction substantially at time t₁ is explained in more details below. The measured values p₁ and p₂ are preferably the wind pressure at time t₁ and t₂ and rotor positions φ₁ and φ₂. The wind pressure can easily be transformed to wind speed by simple calculations.

The calculation may also involve a further measurements e.g. at third measurement of p₃ at rotor position φ₃ at time t₃ where the position φ₃ and the time t₃ are different from time t₁ and t₂ and rotor positions φ₁ and φ₂.

The present invention also relates to a system for determining the wind speed as described below.

A system for determining the wind speed or the wind direction experienced by a wind turbine having a tower, a nacelle, and a rotor including a hub, a number of wind turbine blades mounted to said hub, and a spinner surface for diverting an airflow around said hub, such that a wind turbine setting such as an inflow angle may be adjusted based on the determined wind speed or wind direction, said system comprising:
an angular sensor for determining the rotor position,
an airflow sensor for mounting at said spinner surface, and rotating with said rotor such that an airflow variable may be determined by means of said airflow sensor as a function of rotor positions during a rotation of said rotor, said airflow variable varying with said rotor position when said inflow angle error being different from zero,
a processing unit being configured for determining a first airflow value corresponding to the value of said airflow variable at a first rotor position, and a second airflow value corresponding to the value of said airflow variable at a second rotor position,

said processing unit further being configured for determining the wind speed or the wind direction experienced by said wind turbine as a function of said first airflow value, and said second airflow value.

The invention will now be explained in more detail below by means of examples with reference to the accompanying drawings, in which

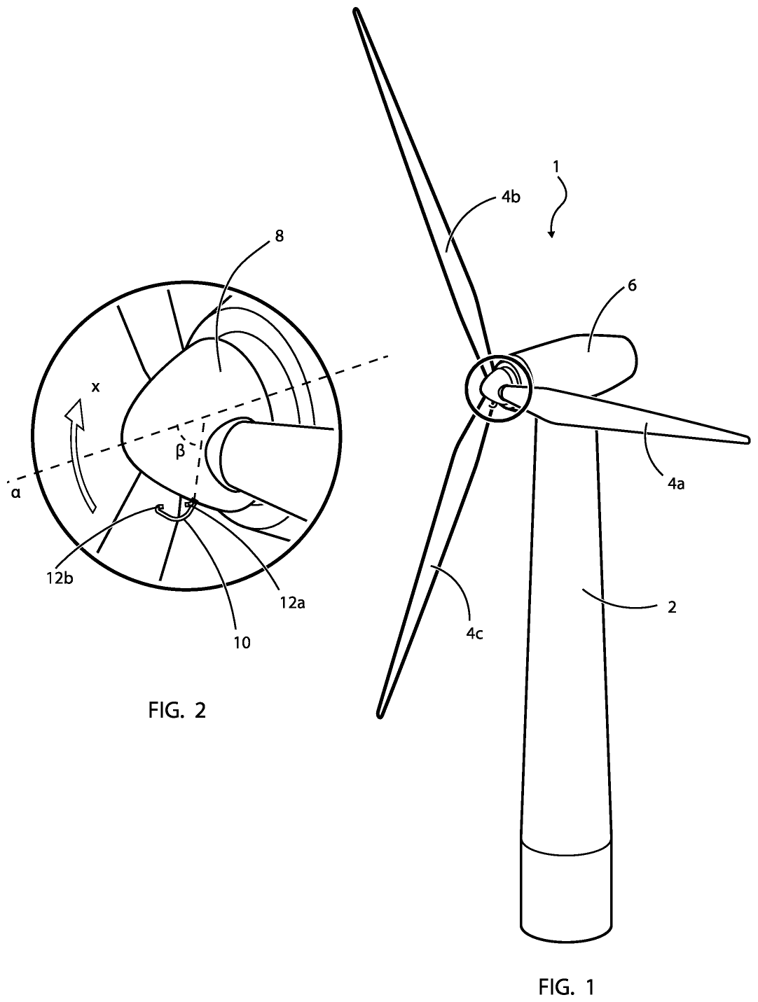

FIG. 1 shows a wind turbine.

FIG. 2 shows a magnification of the part of the wind turbine included in the circle of FIG. 1.

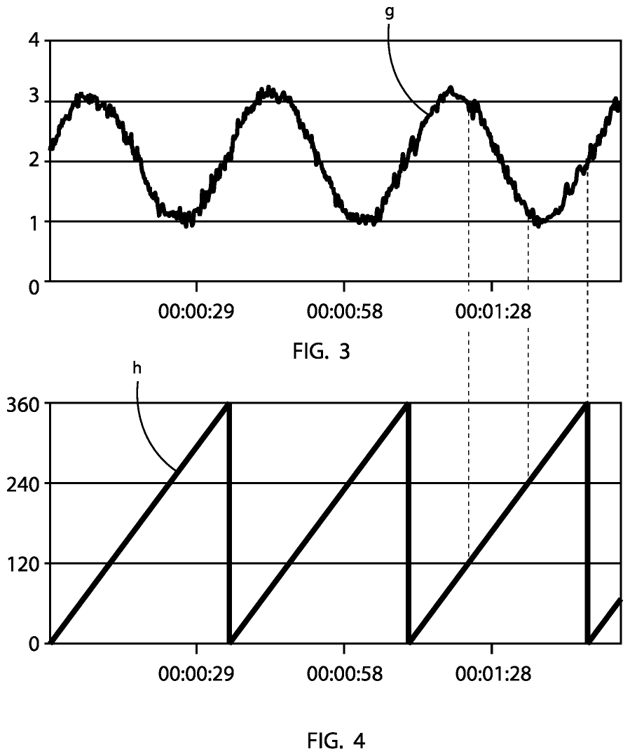

FIG. 3 shows the air velocity as a function of time.

FIG. 4 shows the rotor position as a function of time.

The invention may, however, be embodied in different forms than depicted below, and should not be construed as limited to any examples set forth herein. Rather, any examples are provided so that the disclosure will be thorough and complete, and will fully convey the scope of the invention to those skilled in the art. For the same reason reference numerals refer to the same elements throughout the description. For the same reason elements will, thus, not be described in detail with respect to the description of each figure.

FIG. 1 shows a wind turbine 1 of a three-bladed horizontal-axis tower design comprising a tower 2, a nacelle 6, and a rotor with the wind turbine blades being upwind of the tower and designated the reference numerals 4a, 4b, 4c.

The rotor includes a hub, to which the three wind turbine blades are mounted. The rotor rotates around a rotor axis—the rotor axis goes through the center of the rotor, and is substantially in a horizontal plane as the name of the wind turbine design indicates (in practice there may be an inclination of about 5°).

A spinner 8 covers the hub and has a spinner surface with a curvature so that the airflow may be diverted smoothly around the center of the rotor. The spinner surface is illustrated as a semi-sphere, but it may also have a planar front face or another shape.

FIG. 2 shows a magnification of the part of the wind turbine included in the circle of FIG. 1—specifically the center of the rotor, which includes the hub covered by the spinner surface.

An airflow sensor 10 is shown at said spinner surface. The airflow sensor is mounted with an offset with respect to the center of the rotor. With respect to the rotor axis, the airflow sensor is mounted with an offset about β=35°, i.e. the airflow sensor is mounted with a sensor position angle with respect to the rotor axis (rotor shaft axis), the sensor position angle may be in the range 10°-65°.

For a flat spinner surface with the airflow sensor mounted on the planar part of the spinner surface, the offset may be chosen so that the distance to the shaft axis is in the range 0.5 m-2 m.

The airflow sensor may be a one-dimensional sonic sensor comprising a sensor body (housing), which may house the electronics and signal processing means.

The 1D sonic sensor may further comprise a bent rod, and two sensor heads attached to the bent rod opposite to each other (a proximal sensor head 12a, and a distal sensor head 12b—the proximal sensor head being closer to the point where the bent rod protrudes from the spinner surface than the distal sensor head).

Alternatively, the sensor may have two rods such that the proximal sensor head may be attached to a second rod, which extends from the spinner surface along side the first rod—the second rod extending a shorter distance than the first rod.

The airflow sensor may measure the air velocity (airflow variable) in a direction, which has a (measurement) angle to the tangential airflow flowing over the spinner surface at the location of the sensor, i.e. the velocity of the air flowing from the distal sensor head to the proximal sensor head may be measured.

The measurement angle may be about 35° or in general in the range of 0°-90°.

The sensor body is mounted to the inside of the spinner and the bent rod and sonic sensor heads protrude through a hole in the spinner. In this way, the sensor unit can easily be exchanged from the inside of the spinner, by detaching the sensor body from the spinner and retracting the bent rod and sonic sensor heads through the hole in the spinner.

The arrangement of the airflow sensor has the additional advantage that the distal sensor head does not disrupt the airflow through the sensor. This results in a more accurate reading of the airflow over the spinner surface.

Since the airflow sensor is mounted with an offset, the airflow sensor moves along a circular path as the rotor rotates.

A sound wave may be sent from the first sensor head to the second sensor head. The second sensor head receives the sound wave, and a second sound wave is sent from the second sensor head to the first sensor head.

The air velocity, in the direction between the tips, can be determined by the difference in the time it takes for the two sound waves to travel the distance between the two sensor tips. These sensors have no moving parts and are therefore very robust. They can also be heated in order to prevent ice build-up in cold climates.

As an alternative to a 1D sonic anemometer, a pitot tube, a savonious rotor, a propeller anemometer, or a cup anemometer may be used.

FIG. 3 shows the air velocity as measured by the airflow sensor for a little more than three rotations of the rotor as a function g of time.

The graph exhibits a sinusoid shaped curve with a relative small amount of noise (the high frequency fluctuations), which is indicative of a fairly small amount of turbulence/non laminar airflow during the tree rotations.

The sinusoid stems from the fact that the airflow sensor moves along a circular path as the rotor rotates.

The amplitude of the sinusoid increases with the inflow angle error, i.e. if the wind turbine is completely aligned to the direction of the wind, the inflow angle is zero and the measured air velocity as a function of the rotor rotating is constant.

More turbulent wind conditions may result in an air velocity which does not appear as sinusoid as the curve in FIG. 3 due to the high frequency fluctuations being greater.

Not shown in FIG. 1 is an angular sensor for determining the rotor position—the rotor position is to be understood as the rotation angle of the rotor. The angular sensor such as an accelerometer may be located inside the sensor body of the airflow sensor.

The angular sensor may be used to determine the airflow variable (air velocity V) as a function ƒ of rotor position x such that a given rotor position x may be mapped to an airflow value V=ƒ(x) by the function ƒ. The rotor position is defined as x=0°=360° when the airflow sensor is at its highest position.

The two sensors may sample such that for every measured/determined rotor position value there is exactly one measured airflow value—these two values define an ordered pair.

For a full rotation two ordered pairs of airflow value and rotor position may be collected/measured (x₁, V₁) and (x₂, V₂).

Alternatively, three ordered pairs of airflow value and rotor position may be collected/measured per rotation of the rotor—the sampling frequency of the two sensors (airflow sensor and angular sensor) may be even higher such that they sample up to 10 samples per second.

FIG. 4 shows the rotor position from 0° to 360° as a function h of time for a little more than three rotations—the rotor position being measured by the angular sensor.

The airflow variable as a function of rotor position is then ƒ=g(h(⋅)).

The measurement of the air velocity at the spinner surface may be used to determine the wind speed as well as the wind direction experienced by the wind turbine (free wind speed U, angle of attack relative to the rotor axis θ and azimuth angle φ on the spinner) by the following three relationships:

V₁=V(360)=U(K₁ cos θ+K₂ sin θ cos φ)

V₂=V(∂₁)=U(K₁ cos θ+K₂ sin θ cos(φ+∂₁))

V₃=V(∂₂)=U(K₁ cos θ+K₂ sin θ cos(φ+∂₂))

V₁, V₂ and V₃ are measured within one rotation of the rotor by the airflow sensor.

K₁, K₂ are constants. The two constants can be checked by measurements of wind speed and wind direction from a free mast (K₁) and measurements during yawing of the wind turbine (K₂), i.e. K₁ relates to a nacelle transfer function (the transfer function between the free wind speed and the nacelle wind speed (wind speed measured behind the rotor). The free wind speed may be measured by a sensor on a mast 2.5 rotor diameters from the wind turbine for example.

A spinner transfer function is the transfer function between the free wind speed and the wind speed at the center of the rotor just in front of the rotor, i.e. typically at the spinner surface.

K₂ tells about the shape of the spinner surface. The constant K_{α}=K₁/K₂ is chosen such that the same wind speed is measured during the yawing.

During calibration for determining the constants, there may be measured over a period in order to find the average best constants.

Alternatively, the two constants may be determined by numerical simulations (computational fluid dynamic) with Navier-Stokes equations as basis for the simulation/model.

Typical values for the constants are K₁=0.75211 and K₂=0.92183.

The two parameters ∂₁ and ∂₂ are a first phase and a second phase respectively, and correspond to the angular positions where the airflow sensor takes measurements. It may be chosen that the parameter ∂₂=2∂₁, and may take on the values ∂₁=120° and ∂₂=240° respectively, i.e. the airflow sensor may measure air velocity at three equidistant angles (rotor positions). However, the rotor positions need not be equidistant.

Thus, V₂ is an air velocity also measured by the airflow sensor, but at a different rotor position than where the air velocity V₁ was measured, i.e. the value of the output of the airflow sensor at a previous position of the rotor may be warped and used together with the value of the output of the airflow sensor at a current position in order to determine the wind speed experienced by the wind turbine.

V₃ is an air velocity also measured by the airflow sensor, but at a different rotor position than where the air velocities V₁ and V₂ were measured.

For example, the airflow sensor may measure at rotor positions of 120°, 240°, and 360°. This is illustrated by the three vertical striped lines extending from the graph in FIG. 4 to the graph in FIG. 3, i.e. as the rotor rotates the airflow sensor measures air velocity and the rotor position is also measured which means that for a given rotor position, the respective air velocity is also known.

The three above-mentioned relationships may then be solved for the three unknown variables (free wind speed U, angle of attack relative to the rotor axis θ and azimuth angle φ on the spinner). This may be done either analytically or numerically.

The wind speed experienced by the wind turbine as a function of the first airflow value, the second airflow value and the third airflow value may be determined as:

$$U = ( {V}_{1} , {V}_{2} , {V}_{3} ) = \frac{{V}_{1} + {V}_{2} + {V}_{3}}{3 {K}_{1} cos θ}$$

$$where$$

$$θ = arctan \frac{{K}_{1} ( {V}_{2} - {V}_{1} )}{{K}_{2} ( {V}_{1} cos ( φ + 2 π / 3 ) - {V}_{2} cos φ )}$$

$$and$$

$$φ = arctan \frac{\sqrt{3} ( {V}_{2} - {V}_{3} )}{{V}_{2} + {V}_{3} - 2 {V}_{1}}$$

This solves the problem that for more turbulent wind conditions there will be an inconsistency when going back in time to what amounts to an average of ⅓ the time of a rotation and use the airflow measurement at that point in time, i.e. it is not certain that ⅓ the time of a rotation on average corresponds to ⅓ of a rotation. When the airflow is purely laminar there may not be an inconsistency.

As an alternative, only two ordered pairs may be used for determining the free wind speed U, angle of attack relative to the rotor axis θ and azimuth angle φ on the spinner.

The starting point is that according to irrational flow theory, the tangential airspeed of the airflow around a sphere at a certain point can be written as:

$${V}_{x} = U sin ( β ) ( 1 + \frac{{R}^{3}}{2 {( R + d )}^{3}} )$$

where R is the radius of the spinner (provided the spinner surface is spherically shaped), and d is distance or height above the spinner surface in which the sensor measures.

For more complex shapes of the spinner surface there may not be closed form analytical expressions, and a numerical calculation may be needed instead.

In the xy-plane the azimuth angle φ may be determined by measuring V₁=ƒ(270) and determining V₂=ƒ(90), which then constitute the two ordered pairs. The ratio between the two is termed:

$$F = \frac{{V}_{1}}{{V}_{2}}$$

From this ratio, the azimuth angle φ may be determined from the following inverse trigonometric function:

$$φ = arctan ( \frac{1 - F}{1 + F} tan β )$$

The free wind speed U may be determined as:

$$U = \frac{{V}_{1}}{sin ( β - φ ) ( 1 + \frac{1}{2} {( \frac{R}{R + d} )}^{3} )}$$

For the determination of the angle of attack, the two ordered pairs are V₁=ƒ(180) and V₂=ƒ(0) used for the ratio, which enters the inverse trigonometric function defined above.

Below is a list of reference signs used in the detailed description of the invention and in the drawings referred to in the detailed description of the invention.
1 Wind turbine
2 Tower
4a First wind turbine blade
4b Second wind turbine blade
4c Third wind turbine blade
6 Nacelle
8 Spinner surface
10 Airflow sensor
12a Proximal sensor head
12b Distal sensor head
β Offset
α rotor axis
x rotor position

1. A method for determining the wind speed or the wind direction experienced by a wind turbine such that a wind turbine setting such as an inflow angle error may be adjusted based on the determined wind speed or wind direction, said method comprising:
providing said wind turbine having a tower, a nacelle, and a rotor,
said rotor including a hub, a number of wind turbine blades mounted to said hub, and a spinner surface for diverting an airflow around said hub, said method further comprising:
providing an angular sensor, and determining the rotor position by means of said angular sensor,
providing an airflow sensor at said spinner surface, said airflow sensor rotating with said rotor during rotation of said rotor,
determining an airflow variable by means of said airflow sensor as a function of rotor positions during a rotation of said rotor, said airflow variable varying with said rotor position when said inflow angle error being different from zero,
determining a first airflow value corresponding to the value of said airflow variable at a first rotor position,
determining a second airflow value corresponding to the value of said airflow variable at a second rotor position, said second rotor position being substantially ⅙ to 4/6 of a rotation before said first rotor position, and
determining the wind speed or the wind direction experienced by said wind turbine as a function of said first airflow value, and said second airflow value.

2. The method according to claim 1, comprising determining a third airflow value corresponding to the value of said airflow variable at a third rotor position, and determining the wind speed or the wind direction experienced by said wind turbine as a function of said first airflow value, said second airflow value, and said third airflow value.

3. The method according to claim 1, said airflow sensor being an air velocity sensor or an air pressure sensor for measuring an air velocity or an air pressure respectively.

4. The method according to claim 1, said airflow variable being an air velocity or an air pressure.

5. The method according to claim 1, said airflow sensor determining said airflow variable at said spinner surface,
or said single airflow sensor extending from said spinner surface for determining said airflow variable at a distance from said spinner surface.

6. The method according to claim 1, providing a single air flow sensor.

7. The method according to claim 1, said second rotor position being substantially ⅓ of a rotation before said first rotor position.

8. The method according to claim 1, said third rotor position being substantially 2/6 to ⅚ of a rotation before said first rotor position.

9. The method according to claim 8, said third rotor position being substantially ⅔ of a rotation before said first rotor position.

10. A method for determining the wind speed or the wind direction experienced by a wind turbine such that a wind turbine setting such as an inflow angle error may be adjusted based on the determined wind speed or wind direction, said method comprising:
providing said wind turbine having a tower, a nacelle, and a rotor,
said rotor including a hub, a number of wind turbine blades mounted to said hub, and a spinner surface for diverting an airflow around said hub, said method further comprising:
providing an angular sensor, and determining the rotor position by means of said angular sensor as a function of time during a rotation, said rotor position being determined at least at a first rotor position,
providing an airflow sensor at said spinner surface, said airflow sensor rotating with said rotor during rotation of said rotor,
determining the values of an airflow variable by means of said airflow sensor as a function of time during a rotation of said rotor, the values of said airflow variable varying with said rotor position when said inflow angle error being different from zero,
at a second rotor position: a) determining at which first time point said rotor was at said first rotor position, b) determining the value of said airflow variable at said second rotor position, and determining the value of said airflow variable at said first time point corresponding to when said rotor was at said first rotor position, c) determining the wind speed or the wind direction experienced by said wind tur bine as a function of the value of said airflow variable at said second rotor position and the value of said airflow variable at said first time point corresponding to when said rotor was at said first rotor position.

11. A system for determining the wind speed or the wind direction experienced by a wind turbine having a tower, a nacelle, and a rotor including a hub, a number of wind turbine blades mounted to said hub, and a spinner surface for diverting an airflow around said hub, such that a wind turbine setting such as an inflow angle may be adjusted based on the determined wind speed or wind direction, said system comprising:
an angular sensor for determining the rotor position,
a single airflow sensor for mounting at said spinner surface, and rotating with said rotor such that an airflow variable may be determined by means of said single airflow sensor as a function of rotor positions during a rotation of said rotor, said airflow variable varying with said rotor position when said inflow angle error being different from zero,
a processing unit being configured for determining a first airflow value corresponding to the value of said airflow variable at a first rotor position, and a second airflow value corresponding to the value of said airflow variable at a second rotor position, said second rotor position being substantially ⅙ to 4/6 of a rotation before said first rotor position, said processing unit further being configured for determining the wind speed or the wind direction experienced by said wind turbine as a function of said first airflow value, and said second airflow value.
